(19) United States
(12) Patent Application Publication
(10) Pub. No.: US 2002/0023019 A1
(43) Pub. Date: Feb. 21, 2002

(54) Sale quantity information coordination service system, sales promotional information coordination service system, terminal device and medium

(76) Inventor: Yasuhiro Kawakita, Osaka (JP)

Correspondence Address: VENABLE, Post Office Box 34385, Washington, DC, 20043-9998, US

(21) Appl. No.: 09/901,698

(22) Filed: Jul. 11, 2001

(30) Foreign Application Priority Data
Jul. 27, 2000 (JP) 2000-226533
Jul. 27, 2000 (JP) 2000-226547

(51) Int. Cl. G06F 17/60

(52) U.S. Cl. 705/26

(57) ABSTRACT

In order to provide a coordination service system which enables an efficient purchase of a process element required to implement a specific process based upon sale quantity information or sales promotional information, a coordinator terminal 102, which comprises a means for sale quantity information request that issues a request for sale quantity information with respect to process elements included in an information page to at least one process element provider terminal in response to a request from a shopper terminal, a means for compilation that compiles a plurality of sets of sale quantity information provided by a plurality of process element provider terminals in a specific format and a means for providing sale quantity information that provides the compiled sale quantity information to the shopper terminal that has requested the sale quantity information, is connected to a network 103.

### BACKGROUND OF THE INVENTION

1. Field of the Invention

The present invention relates to a sale quantity information coordination service system, a sales promotional information coordination service system, a terminal device and a medium, and more specifically, it relates to a sale quantity information coordination service system and the like that allow a shopper to search various services and purchase a product on-line from a shopper terminal connected to a network, a typical example of which is the Internet.

2. Description of the Related Art

In recent years, systems through which service providers provide various types of products, information (also referred to as data or content) and services and shoppers make purchases by viewing such products and the like via a computer network such as the Internet have been achieved. A shopper purchases a product or the like through such a system by placing an order to a vendor selling products that may be information including cooking recipes or cooking ingredients, for instance, from the viewing screen at the shopper terminal via the network.

When purchasing ingredients required in a cooking recipe selected through the system, the shopper decides on the ingredients that he needs to purchase by reading the recipe and calculates the quantities of ingredients necessary to serve a specific number of people. Then, he visits a local store selling the ingredients and purchases the ingredients in the sale units offered at the store. If all the ingredients cannot be purchased at a single store, he visits another store until he obtains all the ingredients in quantities enough to serve the specific number of people.

When obtaining ingredients through this method, the calculation of the quantities of ingredients required to serve a specific number of people is normally the most complicated part of the process. When cooking several different dishes, the necessary ingredients may overlap, and the calculation of ingredient quantities becomes especially complicated.

In order to simplify this process, Japanese Unexamined Patent Publication No. 121614/1995 (“Product Guide Apparatus”), for instance, discloses an apparatus that automatically calculates the necessary ingredient quantities and prices for the shopper who simply inputs a specific menu number and the number of people to be served. Since information such as types of ingredients available at a given store, the sale units and the unit prices is pre-registered in the system disclosed in the publication, the shopper needs only to input a menu number and the number of people to be served to have the apparatus calculate purchase quantities based upon the ingredient quantities needed by the shopper and the sale unit quantities and provide the shopper with the purchase price. A purchaser using the system described above inputs a menu number and the number of people to be served at a terminal device installed in the store to immediately ascertain the quantities of ingredients required and the prices.

It is to be noted that process element information such as the types of ingredients available at process element providers, the sale units and the unit prices varies among different process element providers. In the following explanation, the information that includes the sale units and the unit prices of such process elements is referred to as sale quantity information.

In addition, computer network systems which allow shoppers to search for a specific recipe at a cooking recipe site (information page) on the network such as the Internet have been in existence in recent years, as well.

Such a system allows a shopper to make an on-line purchase of, for instance, necessary cooking ingredients at an Internet shop from the viewing screen at the shopper terminal via the network. In addition, the Internet shop may provide information about process elements which will promote sale such as products offered at discount prices in a newspaper flyer or the like. Such systems are introduced in an article headlined “The Advent of Internet Fresh Produce Shops” in the Nippon Keizai Shinbun of May 20th, 2000.

With a comprehensive network environment coming into existence as described above, the shopper can now search for a desired recipe and purchase the necessary ingredients entirely on the Internet.

However, there is a problem with the systems in the prior art in that since the terminal device is installed in a store where ingredients are sold, the shopper must go to the store to use the device. Namely, the shopper cannot select a cooking recipe and the necessary ingredients while checking which ingredients he already has at home.

In addition, since the systems in the prior art operate in conjunction with a device that functions only within a given store, information cannot be shared among different store branches or among stores belonging to different operators. Furthermore, since cooking recipes offered through such a system are limited to those that require ingredients offered at the store, the shopper cannot access cooking recipes that require ingredients not available at the store. Thus, the shopper cannot always obtain the desired recipe or ingredients. Moreover, since the units in which ingredients are sold are determined by individual stores, the shopper cannot select the sale units and, as a result, the shopper may have to purchase ingredients in greater quantities than necessary.

### SUMMARY OF THE INVENTION

Accordingly, a first object of the present invention is to provide a new and improved sale quantity information coordination service system that enables an efficient purchase of a process element required in a process based upon sale quantity information.

In addition, since cooking recipes offered at a given cooking recipe site in the prior art do not always use ingredients available at discount prices, information on sale items offered at an Internet shop cannot be utilized in conjunction with another cooking recipe site. Thus, it is necessary to undergo a complicated process of first obtaining information on sale items at an Internet shop, deciding on a recipe by searching for a cooking recipe that uses a sale item as an ingredient at a cooking recipe site and then purchasing ingredients required in the selected recipe at the Internet shop, when cooking with a sale item as an ingredient.

If necessary ingredients are to be purchased at an Internet shop or a street store after deciding on a recipe by first searching for a recipe at a cooking recipe site, some of the ingredients may not be available at sale prices.

Thus, in order to cook with ingredients offered at sale prices, the shopper must effectively utilize discount information on the ingredients provided by an ingredient provider at an Internet shop.

Accordingly, a second object of the present invention is to provide a new and improved sales promotional information coordination service system that enables an effective purchase of a process element required to implement a specific process based upon sales promotional information such as discount information.

In order to achieve the objects described above, in an aspect that represents the invention in the present application, a sale quantity information coordination service system, which is constituted by connecting via a network a plurality of process method provider terminals at each of which an information page is provided offering information on, at least, a specific process method and process elements required to implement the specific process, a plurality of process element provider terminals at each of which sale quantity information comprising, at least, sale units and sale prices of the process elements required to implement the specific process is provided, a shopper terminal and a coordinator terminal comprising a means for sale quantity information request that issues a request for sale quantity information with respect to the process elements included in the information page to, at least, one process element provider terminal in response to a request from the shopper terminal, a means for compilation that compiles a plurality of sets of sale quantity information provided by the plurality of process element provider terminals in a specific format and a means for providing sale quantity information that provides the compiled sale quantity information to the shopper terminal that has requested the sale quantity information, is provided.

According to the present invention, with process elements such as required ingredients and their quantities simply specified through an information page at a process method provider such as an ingredient provider, information from a plurality of ingredient providers is taken in hand the compiled information is provided at the shopper terminal. As a result, the shopper can plan on the purchase quantities and the purchase prices of process elements such as ingredients at home. In addition, since information from a plurality of process element providers such as ingredient providers is first compiled and then the compiled information is provided at the shopper terminal, the shopper has access to more information and more options with regard to the process elements he needs to purchase.

Furthermore, since data provided at process method provider sites that offer information on process methods such shows cooking recipes on the and network and data provided at providers sites that provide process elements such as ingredients on the network are utilized, full ingredients can be obtained more easily at all times compared to through a service in the prior art that is offered through a single store. Moreover, even a process element provider such as an ingredient provider, who does not offer information on process methods such as cooking recipes, can immediately start providing services simply by becoming connected to the network.

In another mode that represents the invention in the present application, a sales promotional information coordination service system, which is constituted by connecting via a network a plurality of process method provider terminals at each of which an information page offering information on a specific process method is provided, a plurality of process element provider terminals at each of which information related to process elements required to implement the specific process is provided, a shopper terminal and a coordinator terminal comprising a means for process element provider terminal registration that registers the process element provider terminals, a means for process method provider terminal registration that registers the process method provider terminals, a means for sales promotional information registration that registers information related to process elements, the sales of which are being promoted by the process element providers, a means for providing sales promotional information that provides the registered sales promotional information to the process method provider terminals, a means for process element provider terminal verification that verifies whether or not the process element provider terminals are registered when registering the sales promotional information, a means for process method provider terminal verification that verifies whether or not the process method provider terminals requesting the sales promotional information are registered and a means for charging that charges a process element provider terminal that has registered sales promotional information for a fee, is provided.

According to the present invention, it becomes possible to provide a process method provider with information on process elements, the sales of which are being promoted, such as discount information. In addition, since the use of a specific type of sales promotional information by a process method provider leads to the purchase of a process element by a shopper, the purchase is considered to be the end result of a specific process element provider registering the sales promotional information, and thus, a fee can be charged to the process element provider who registered the sales promotional information. Moreover, by providing better sales promotional information on process elements offered at more competitive prices that are more likely to be selected to be featured in a process method information page, a process element provider can improve the sales of the process elements.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is a block diagram illustrating the structure of the sale quantity information coordination service system in a first embodiment;

FIG. 2 is a flow chart of the operation achieved in the sale quantity information coordination service system in the first embodiment;

FIG. 3 shows an example of a cooking recipe site displayed at the shopper terminal in the first embodiment;

FIG. 4 shows an example of a cooking recipe site displayed at the shopper terminal in the first embodiment;

FIG. 5 shows an example of a cooking recipe site displayed at the shopper terminal in the first embodiment;

FIG. 6 shows an example of a cooking recipe site displayed at the shopper terminal in the first embodiment;

FIG. 7 shows an example of a cooking recipe site displayed at the shopper terminal in the first embodiment;

FIG. 8 shows an example of a cooking recipe site displayed at the shopper terminal in the first embodiment;

FIG. 9 is a block diagram illustrating the structure of the sale quantity information coordination service system in a second embodiment;

FIG. 10 is a flow chart of the operation achieved in the sale quantity information coordination service system in the second embodiment;

FIG. 11 shows an example of a cooking recipe site displayed at the shopper terminal in the second embodiment;

FIG. 12 shows an example of a cooking recipe site displayed at the shopper terminal in the second embodiment;

FIG. 13 is a block diagram illustrating the structure of the sales promotional information coordination service system in a third embodiment; and

FIG. 14 is a flow chart of the operation achieved in the sales promotional information coordination service system in the third embodiment.

### DETAILED DESCRIPTION OF THE PREFERRED EMBODIMENTS

The following is a detailed explanation of the preferred embodiments of the present invention, given in reference to the attached drawings. It is to be noted that in the following explanation and the attached drawings, the same reference numbers are assigned to components having identical functions and structural features to preclude the necessity for a repeated explanation thereof.

### First Embodiment

An explanation is given on an example in which a shopper purchases ingredients offered as process elements required in a cooking recipe which constitutes a process method, in reference to the sale quantity information coordination service system in this embodiment. It is to be noted that the shopper makes an inquiry on quantities and prices of ingredients required in specific recipes that correspond to the sale units offered at an ingredient provider site via the coordinator terminal and the response to the inquiry is provided to the shopper terminal.

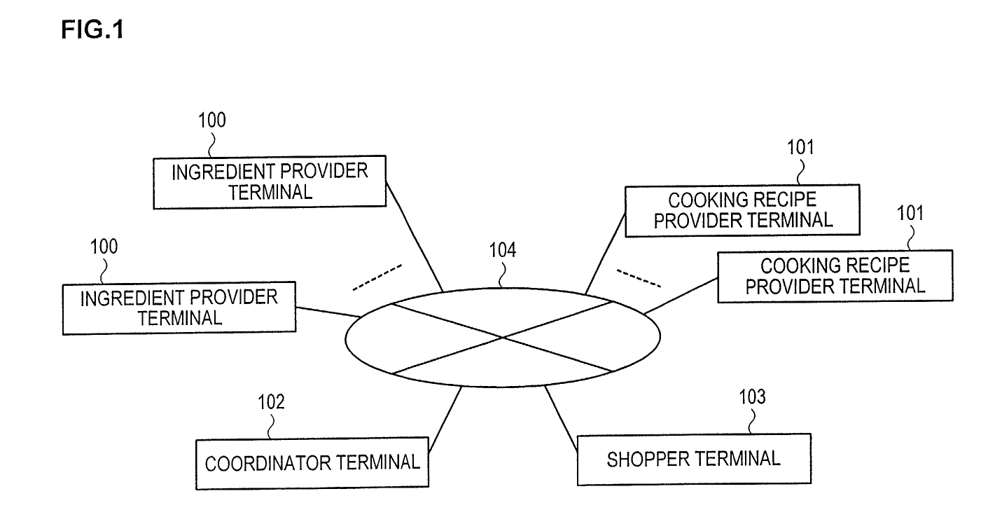

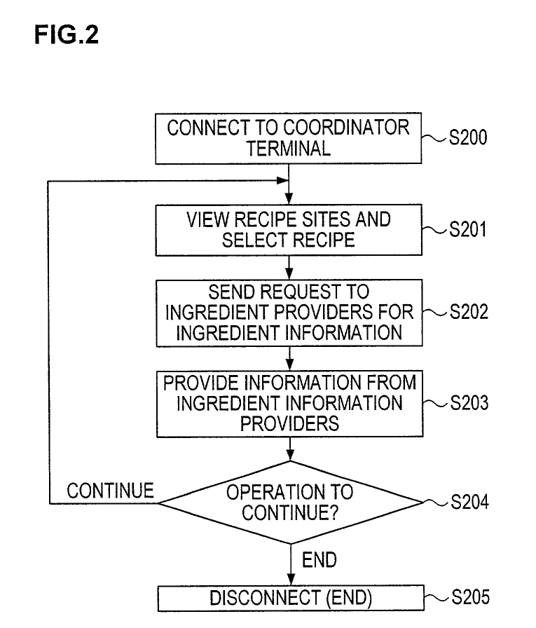

The following is an explanation of the first embodiment given in reference to FIGS. 1 and 2. FIG. 1 is a block diagram illustrating the structure of the sale quantity information coordination service system achieved in the embodiment.

First, as shown in FIG. 1, the sale quantity information coordination service system in the embodiment is constituted by connecting, via a network 104, ingredient provider terminals 100 that provide information on different types of ingredients, sale units, prices and the like, cooking recipe provider terminals 101 that provide cooking recipes, a coordinator terminal 102 and a shopper terminal 103.

The ingredient provider terminals 100 are each provided with a database that stores ingredient information including the names of available ingredients, sale units and prices. The ingredient provider terminal 100 each include a means for transmission that transmits the information on the names of available ingredients, quantities available in correspondence to the sale units and their prices in response to a request for ingredient information transmitted via the network.

The cooking recipe provider terminals 101 are each provided with a database that stores information on names of recipes, ingredients, cooking methods and the like, and the shoppers can view the cooking recipe via the network.

The coordinator terminal 102 is provided with a means for ingredient information extraction that extracts ingredient information constituted of, for instance, required ingredients and quantities in correspondence to a cooking recipe selected by the shopper, a means for ingredient list request that issues a request to a cooking recipe provider site for an ingredient list constituted of, for instance, necessary ingredients and quantities, a means for ingredient information compilation that compiles information on ingredients types and quantities specified at a plurality of cooking recipe provider sites, a means for ingredient information request that issues a request to the ingredient provider terminals for information on available ingredients and quantities and a means for providing ingredient information that provides to the shopper terminal ingredient information such as the names of ingredients, the ingredient quantities offered in correspondence to the sale units and their prices obtained from the ingredient provider terminals, and the like.

The shopper terminal 103 at which the information provided from the cooking recipe provider terminals 101, the information provided from the ingredient provider terminals 100 and the information provided from the coordinator terminal 102 are displayed includes a means for input through which information to be transmitted to the individual terminals mentioned above as necessary is entered.

Next, in reference to FIG. 2, the flow of the operation achieved in the sale quantity information coordination service system in the embodiment is explained. FIG. 2 presents a flow chart provided to illustrate the flow of the operation achieved in the sale quantity information coordination service system in the embodiment.

First, as shown in FIG. 2, the shopper terminal 103 is connected to the coordinator terminal 102 in step S200 (step S200). The shopper may specify the URL of the coordinator terminal 102 with a general-purpose Web browser to connect with the coordinator terminal 102.

In the following step S201, the shopper, through his terminal 103, freely visits a plurality of cooking recipe sites via the coordinator terminal 102 and selects a desired cooking recipe (step S201).

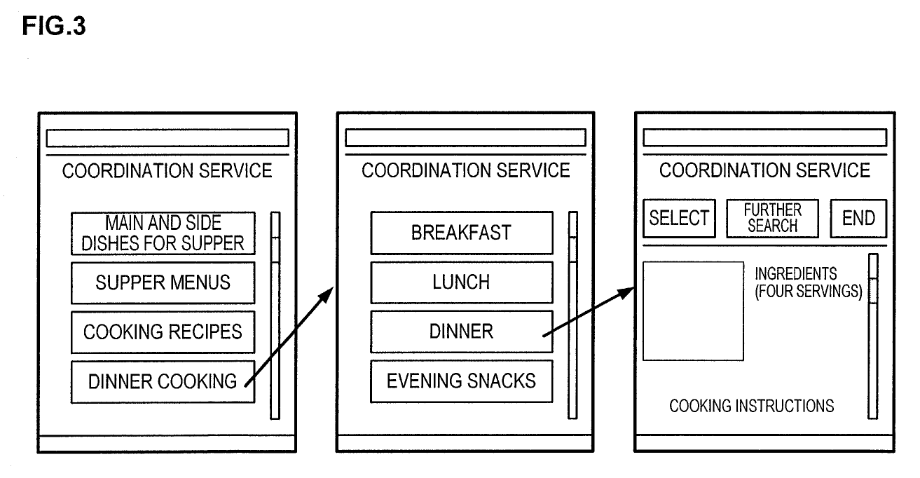

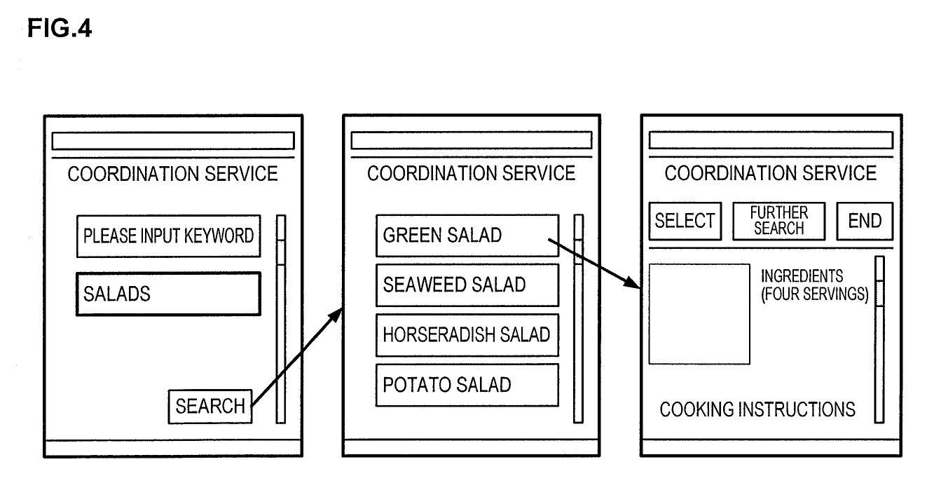

FIGS. 3 and 4 illustrate operations that may be performed to select a cooking recipe at this point. FIGS. 3 and 4 illustrate cooking recipe selection operations.

The shopper may select a cooking recipe by touring a plurality of cooking recipe sites offering cooking recipes and selecting a page offering a desired recipe, as shown in FIG. 3. Alternatively, the shopper may perform a search by entering a key word such as an ingredient name or a theme at a site offering cooking recipes and select a desired cooking recipe from cooking recipes brought up on display, as shown in FIG. 4. As a further alternative, a search engine located at a site offering the cooking recipes may be used to select a desired cooking recipe.

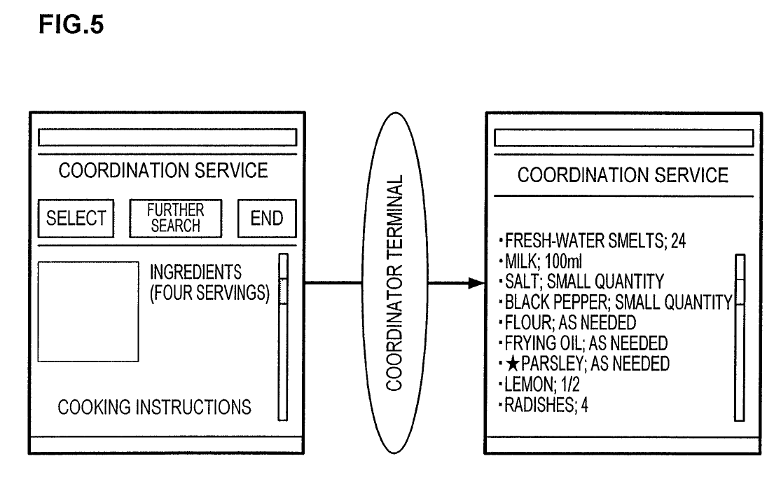

During this process, the ingredient information alone can be extracted from the cooking recipe screen, as shown in FIG. 5, at the coordinator terminal. Namely, the shopper is allowed to extract information on the required ingredients in the selected recipe and their quantities on the screen displaying the selected cooking recipe.

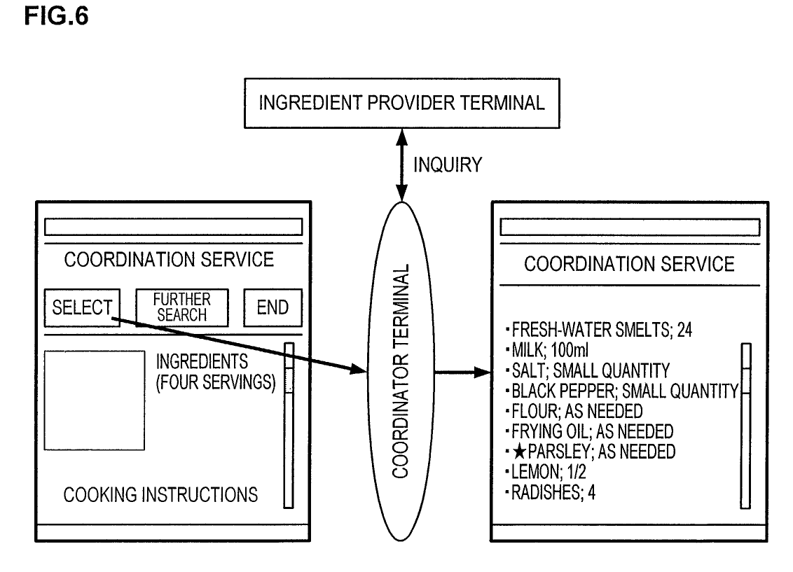

In addition, an ingredient list for the selected cooking recipe can be obtained at the coordinator terminal by issuing a request for the ingredient list to the site providing the cooking recipe, as shown FIG. 6.

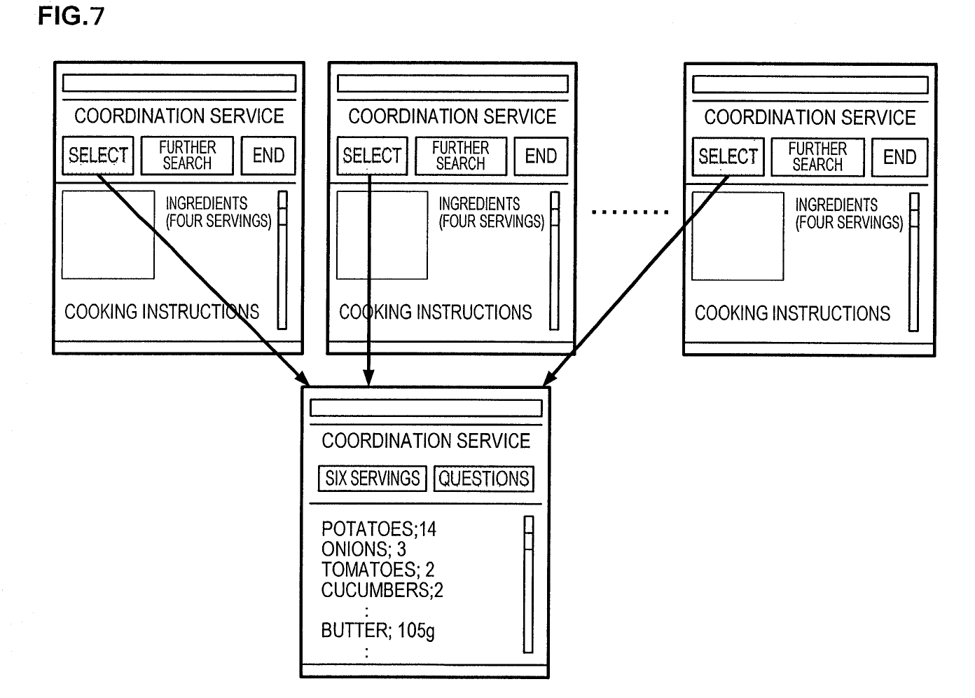

Thus, as shown in FIG. 7, the shopper needs only to visit a plurality of cooking recipe sites and repeatedly select a desired recipe from the display to have compiled information on the required ingredients in the recipes displayed at the shopper terminal. At the shopper terminal, the ingredient quantities for the number of servings (e.g., four servings) specified in the cooking recipe are displayed. If the number of servings varies among different cooking recipes, the ingredient quantities may be converted to those for the number of servings specified in advance in the system (e.g., four servings) for display.

If sale units differ among various cooking recipes, quantities can be converted through a unit conversion table set in advance for uniform display when compiling ingredient quantity information. For instance, by storing “15 cc=1 tbsp.” and “5 cc=1 tsp.” in the unit conversion table, the quantity of 30 cc called for in a cooking recipe can be displayed as “2 tbsp.” on the display providing quantity information in units of spoons.

Next, in step S202, the shopper enters a specific number of servings and presses an inquiry button and, in response, the coordinator terminal 102 transmits an inquiry on the required ingredients and their quantities for the recipes selected by the shopper to the ingredient provider terminals 100 (step S202).

At each ingredient provider terminal 100, a verification is performed to determine whether or not all the required ingredients are available, and if they are available, the ingredient quantities specified at the coordinator terminal 102 are compared with the sale units set for the ingredients. Then, quantities available in the minimum sale units that will provide the shopper with sufficient ingredient quantities and their prices are calculated. Once the quantities corresponding to the sale units and their prices are calculated for all the ingredients specified at the coordinator terminal 102, the ingredient provider terminal 100 transmits the information on the quantities corresponding to the sale units set for the individual ingredients and their prices to the coordinator terminal 102. If some ingredients are not available, the ingredient provider terminal 100 transmits information indicating that all ingredients are not available to the coordinator terminal 102.

Alternatively, when transmitting information on the quantities available in the required sale units and their prices for the ingredients on which the inquiry has been made at the coordinator terminal, the ingredient provider terminal may transmit information only on the ingredients that are available and transmit information indicating that the remaining ingredients are not available.

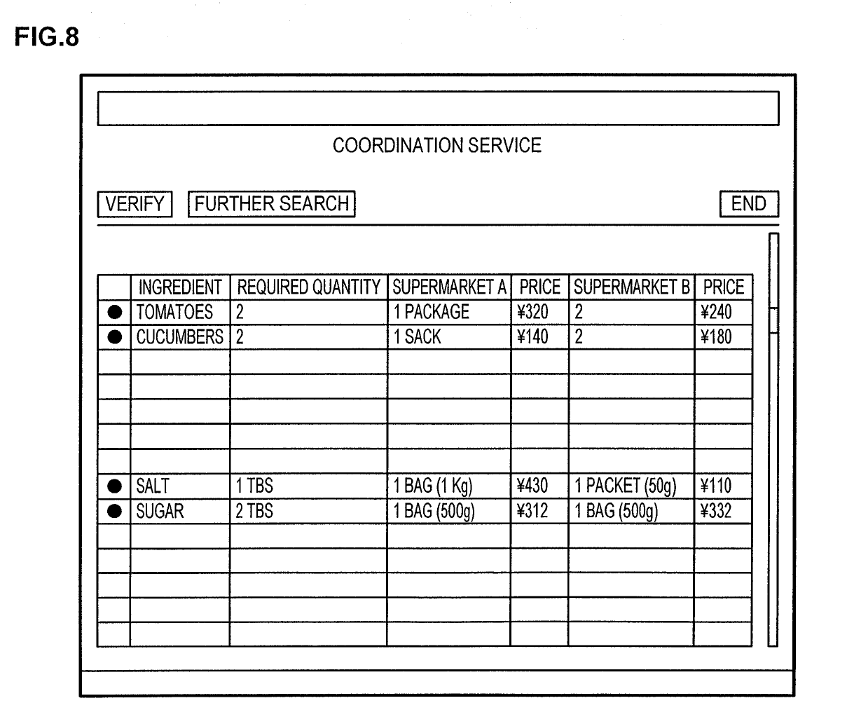

Then, in step S203, the coordinator terminal 102 provides ingredient information obtained from a plurality of ingredient provider terminals 100 to the shopper terminal 104, as shown in FIG. 8 (step S203). The shopper uses the information on the quantities available in the sale units offered by the individual ingredient providers and their prices displayed at the shopper terminal 104 when purchasing the ingredients.

In step S204, a verification is made as to whether or not the search is to be continued (step S204). If the search is to be continued, “continue” is selected and the operation returns to step S201. If, on the other hand, the search is to end, “end” is selected and the operation shifts to step S205 to disconnect the shopper terminal from the coordinator terminal (step S205).

The shopper may actually purchase the ingredients by using the information on the ingredient quantities available in the specific sale units and their prices through any of various channels. For instance, the shopper may make a direct purchase on the net without disconnecting from the coordinator terminal by selecting the ingredients that the shopper wishes to purchase or by changing the purchase quantities after checking the quantities of the ingredients and their prices available based upon the ingredient sale units offered by an ingredient provider with an on-line shop, or the shopper may make a purchase by actually visiting a store located in the neighborhood.

Since the coordinator terminal in the embodiment is a system that operates as part of a network such as the Internet, the shopper can make plans on the quantities of the necessary ingredients to be purchased and their prices at home. In addition, since the shopper is provided with compiled information constituted of a plurality of sets of information provided by various ingredient providers, the shopper has access to more information and more options when purchasing ingredients.

In addition, since data provided at cooking recipe sites and ingredient provider sites on the network are utilized, the likelihood of the shopper being able to obtain the desired recipes and ingredients is greatly improved compared to the likelihood of the shopper obtaining them through a service offered at a single store, as in the prior art. Furthermore, since various ingredient providers offer ingredients in different sale units, the shopper can purchase ingredients in the sale units that will provide him with the correct quantities of the ingredients. Moreover, even an ingredient provider who does not offer cooking recipe information can start to offer a service providing ingredient information simply by connecting with the network.

### Second Embodiment

In this embodiment, the shopper makes an inquiry on the quantities and prices corresponding to the ingredient sale units offered at ingredient provider sites in correspondence to the specific ingredients and the actual quantities required in a specific recipe via the coordinator terminal and the response to the inquiry is provided to the shopper terminal in conformance to personal information registered in advance to simplify the shopper operation.

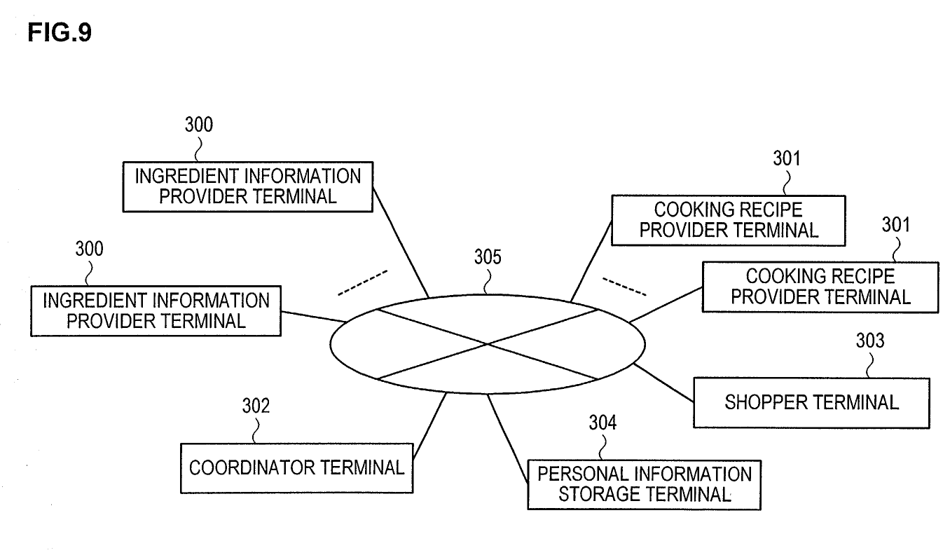

The sale quantity information coordination service system in the second embodiment is explained in reference to FIG. 9. FIG. 9 is a block diagram illustrating the structure of the sale quantity information coordination service system achieved in the embodiment.

First, as shown in FIG. 9, the sale quantity information coordination service system in the embodiment is constituted by connecting, via a network 305, an ingredient provider terminals 300 that provide information on different types of ingredients, sale units, prices and the like, cooking recipe provider terminals 301 that provide cooking recipes, a coordinator terminal 302, a shopper terminal 303 and a personal information terminal 304 that stores specific personal information.

The ingredient provider terminals 300 are each provided with a database that stores ingredient information including the names of available ingredients, sale units and prices. The ingredient provider terminals 300 each include a means for transmission that transmits the information on the names of available ingredients, quantities available in correspondence to the sale units and their prices in response to an inquiry on the types of available ingredients and quantities transmitted via the network.

The cooking recipe provider terminals 301 are each provided with a database that stores information on names of recipes, ingredients, cooking methods and the like, and shoppers can view the cooking recipes via the network.

The coordinator terminal 302 is provided with a means for ingredient information extraction that extracts ingredient information constituted of, for instance, required ingredients and quantities in correspondence to a cooking recipe selected by the shopper, a means for ingredient list request that issues a request to a cooking recipe provider site for an ingredient list constituted of, for instance, necessary ingredients and quantities, a means for ingredient information compilation that compiles information on ingredients types and quantities specified at a plurality of cooking recipe provider sites, a means for ingredient information request that issues a request to the ingredient provider terminals for information on available ingredients and quantities and a means for providing ingredient information that provides to the shopper terminal ingredient information such as the names of ingredients, the ingredient quantities offered in correspondence to the sale units and their prices obtained from the ingredient provider terminals, and the like.

The shopper terminal 303 at which the information provided from the cooking recipe provider terminals 301, the information provided from the ingredient provider terminals 300 and the information provided from the coordinator terminal 302 are displayed includes a means for input through which information to be transmitted to the individual terminals as necessary mentioned above is entered.

At the personal information terminal 304, personal information on the shopper is registered in advance. The personal information terminal 304 performs a personal verification when the shopper is to access the coordinator terminal 302. In addition, when providing ingredient information to the shopper terminal 303, settings related to information the shopper wishes to be provided with are made at the personal information terminal 304. It is to be noted that while an explanation is given in reference to the embodiment on an example in which the personal information terminal 304 is separately provided on the network system, a personal information terminal function may be integrated in the coordinator terminal 302.

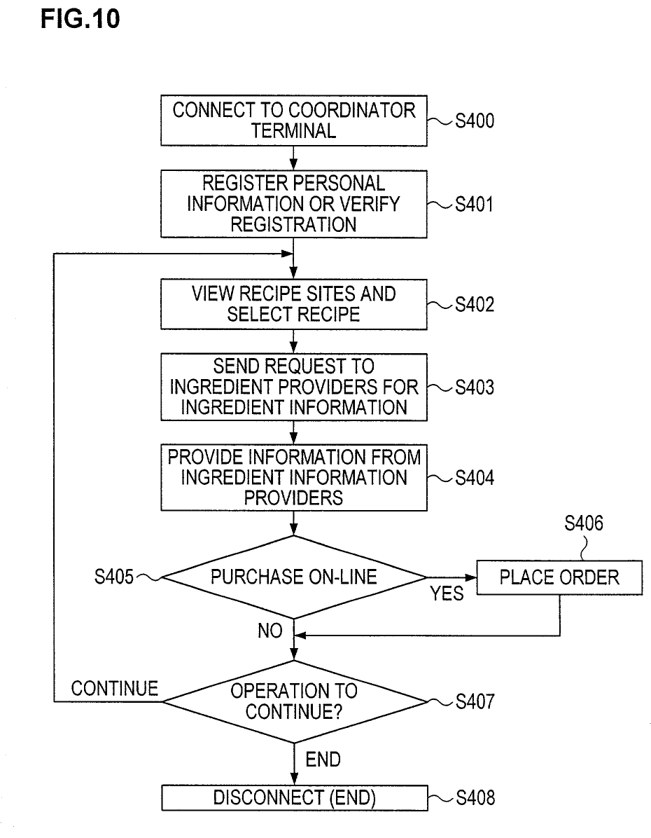

Next, in reference to FIG. 10, the flow of the operation achieved in the sale quantity information coordination service system in the embodiment is explained. FIG. 10 presents a flow chart provided to illustrate the flow of the operation achieved in the sale quantity information coordination service system in the embodiment.

First, as shown in FIG. 10, the shopper terminal 303 is connected to the coordinator terminal 302 in step S400 (step S400). The shopper may specify the URL of the coordinator terminal 302 with a general-purpose Web browser to connect with the coordinator terminal 302.

In the following step S401, a page prompting personal information registration is brought up for a first-time shopper who is using the coordinator terminal for the first time and the shopper's personal information is stored at the personal information terminal 305. If, on the other hand, the shopper has already registered his personal information, a personal verification is performed by referencing the information stored at the personal information terminal 305 before allowing access to the coordinator terminal 302 (step S401). At this point, while access may be allowed even if the shopper does not have his personal information registered, the subsequent service that is offered based upon the personal information will not be made available.

In the following step S402, the shopper connected with the coordinator terminal freely visits a plurality of cooking recipe sites via the coordinator terminal 302 and selects a desired cooking recipe (step S402).

FIGS. 3 and 4 illustrate operations that may be performed to select a cooking recipe at this point. FIGS. 3 and 4 illustrate cooking recipe selection operations.

The shopper may select a cooking recipe by touring a plurality of cooking recipe sites offering cooking recipes and selecting a page offering a desired cooking recipe, as shown in FIG. 3. Alternatively, the shopper may perform a search by entering a key word such as an ingredient name or a theme at a site offering cooking recipes and select a desired cooking recipe from cooking recipes brought up on display, as shown in FIG. 4. As a further alternative, a search engine at the site offering the cooking recipes may be used to select a desired cooking recipe.

During this process, the ingredient information alone can be extracted from the cooking recipe screen, as shown in FIG. 5, at the coordinator terminal. Namely, the shopper is allowed to extract information on the required ingredients in the selected recipe and their quantities on the screen displaying the selected cooking recipe.

In addition, an ingredient list for the selected cooking recipe can be obtained through the coordinator terminal by issuing a request for the ingredient list to the cooking recipe provider site, as shown FIG. 6.

Thus, as shown in FIG. 7, the shopper needs only to visit a plurality of cooking recipe sites and repeatedly select a desired recipe from the display to have compiled information on required ingredients in the recipes displayed at the shopper terminal. At the shopper terminal, the ingredient quantities for the number of servings (e.g., four servings) specified in the cooking recipe are displayed. If the number of servings varies among different cooking recipes, the ingredient quantities may be converted to those for the number of servings specified in advance in the system (e.g., four servings) for display.

If sale units differ among various cooking recipes, quantities can be converted through a unit conversion table set in advance for uniform display when compiling ingredient quantity information. For instance, by storing “15 cc=1 tbsp.” and “5 cc=1 tsp.” in the unit conversion table, the quantity of 30 cc called for in a cooking recipe can be displayed as “2 tbsp.” on the display providing quantity information in units of spoons.

Next, in step S403, the shopper enters a specific number of servings and presses an inquiry button and, in response, the coordinator terminal 302 transmits an inquiry on the required ingredients and their quantities for the recipes selected by the shopper to the ingredient provider terminals 300 (step S403).

At this time, by referencing the information set through the personal information terminal 304, the coordinator terminal 302 issues a request to ingredient providers with on-line shops for the ingredient information if the shopper is registered as an on-line shopper, whereas the coordinator terminal 302 issues a request to ingredient providers that have a store within a specific distance from the shopper's home if the information registered by the shopper indicates that the shopper wishes to purchase ingredients at stores.

As a result, the length of time required for conducting a search is reduced and only the ingredient information provided by suitable ingredient providers is displayed at the shopper terminal 303. It is to be noted that the system may be preset to issue a request to predetermined ingredient providers for ingredient information if no personal information is registered.

At each ingredient provider terminal 300, a verification is performed to determine whether or not the requested ingredients are available. If they are available, the ingredient quantities specified at the coordinator terminal 302 are compared with the sale units set for the ingredients. Then, quantities available in the minimum sale units that will provide the shopper with sufficient ingredient quantities and their prices are calculated. Subsequently, the ingredient provider terminal 300 transmits information on the quantities corresponding to the sale units set for the individual ingredients and their prices to the coordinator terminal 302. If some ingredients are not available, the ingredient provider terminal 300 transmits information indicating that all ingredients are not available to the coordinator terminal 302.

Alternatively, when transmitting information on the quantities available in the required sale units and their prices for the ingredients on which the inquiry has been made from the coordinator terminal, the ingredient provider terminal may transmit information only on the ingredients that are available and transmit information indicating that the remaining ingredients are not available.

In the following step S404, the coordinator terminal 302 provides ingredient information provided from a plurality of ingredient provider terminals 300 to the shopper terminal 303 in accordance with the personal confirmation registered by the shopper (step S404).

The personal information used at this point includes a setting made to indicate selection/non-selection of individual ingredient categories and a setting made to indicate the priority order in which information on a given ingredient provided by different vendors should be displayed. In addition, the personal information may include a specific number of servings set by the shopper.

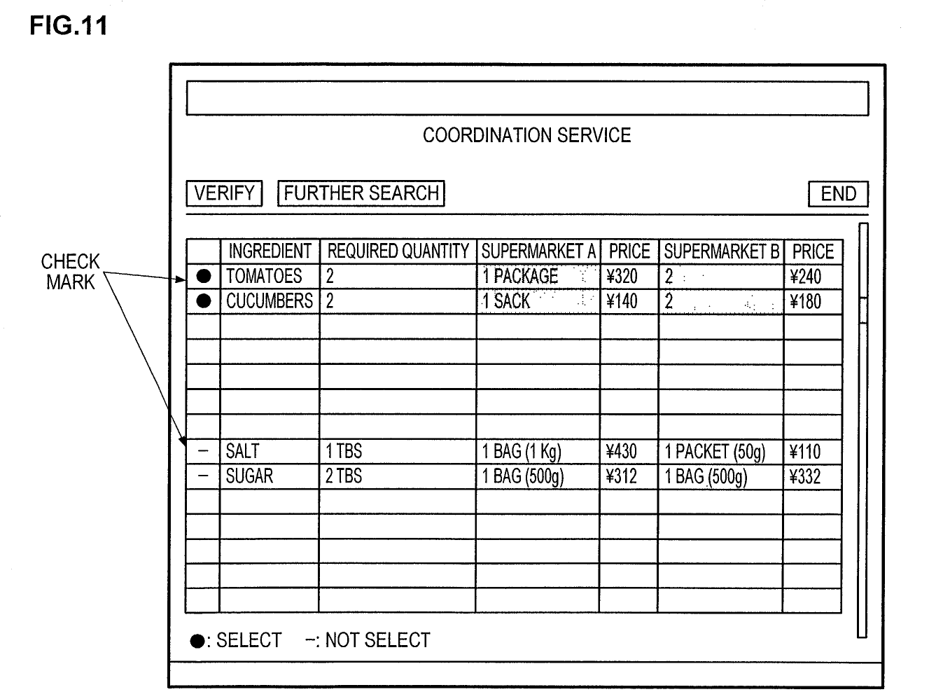

The setting that indicates selection/non-selection of individual ingredient categories is specifically used when purchasing the ingredients at an on-line shop, as shown in FIG. 11. For instance, if the personal information indicates that the shopper does not wish to purchase ingredients in the “seasoning” category, “non-selection” (i.e., with no check mark indicating “purchase”) is indicated at the shopper terminal 303. The other ingredients are displayed with the check marks indicating “purchase” attached, in such a manner that the ingredient quantities can be adjusted.

It is to be noted that if the shopper wishes to change the quantities, he must perform a search again, since the desired purchase quantities may not match the offered sale quantities.

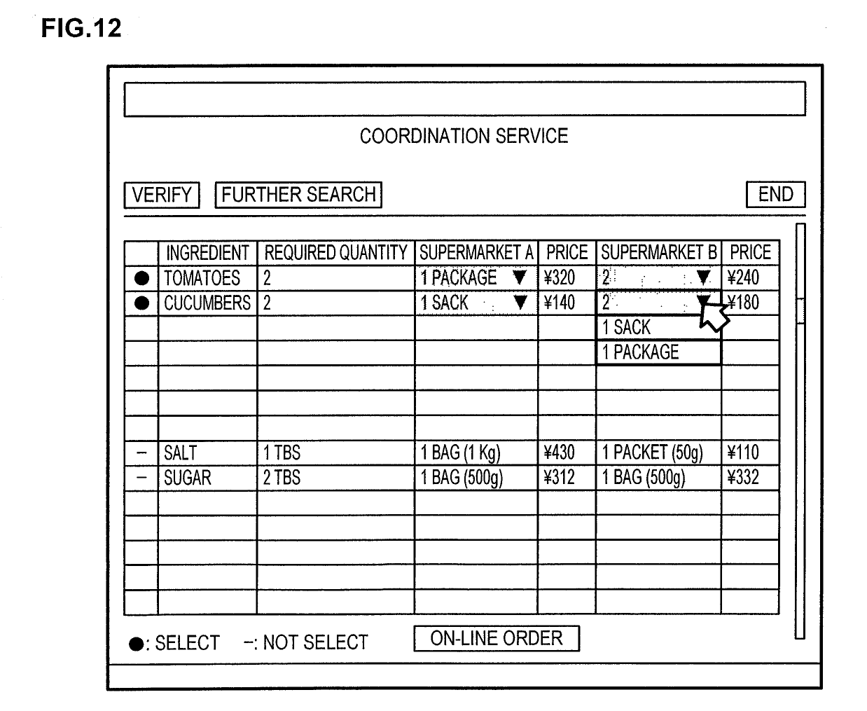

In addition, to display a plurality of sets of information on a given ingredient, the display priority order may be set so that the information indicating the closest match between the required ingredient quantity and the sale unit is displayed first or the information indicating the lowest purchase price is displayed first, as shown in FIG. 12. This setting also allows only the ingredient information satisfying specific conditions to be displayed, with information on other ingredients that does not satisfy the conditions excluded from the display. For instance, a mark (e.g., a pull-down arrow) indicating another choice may be added to allow the shopper to change the display freely.

On the screen displaying the ingredient information provided by the ingredient providers offering the on-line shopping service, a button through which an order is placed is included.

Next, in step S405, a verification is made as to whether or not the shopper wishes to purchase ingredients on-line (step S405). If the shopper wishes to purchase the ingredients on-line, the operation shifts to step S406, in which an order is placed by verifying the ingredient quantities conforming to the sale units for the ingredients offered by an ingredient provider with an on-line shop (step S406). It is to be noted that if no personal information is registered, all the ingredient information provided by the ingredient providers is displayed.

Thus, the shopper can use the information on the quantities and the prices corresponding to the sale units offered by the individual ingredient providers as ingredient information displayed at the shopper terminal 303.

In step S407, a verification is made as to whether or not the search is to be continued (step S407). If the search is to be continued, “continue” is selected and the operation returns to step S402. If, on the other hand, the search is to end, “end” is selected and the operation shifts to step S408 to disconnect the shopper terminal from the coordinator terminal (step S408).

Since the coordinator terminal in the embodiment is a system that operates as part of a network such as the Internet, the shopper can make plans on the quantities of the necessary ingredients to be purchased and their prices at home. In addition, since the shopper is provided with compiled information constituted of a plurality of sets of information provided by various ingredient providers, the shopper has access to more information and more options when purchasing ingredients. In addition, since data provided at cooking recipe sites and ingredient provider of sites on the network are utilized, the likelihood of the shopper being able to obtain the desired recipes and ingredients is greatly improved compared to the likelihood of the shopper obtaining them through a service offered at a single store, as in the prior art.

An ingredient provider who does not offer cooking recipe information, too, can start offering a service providing ingredient information simply by connecting with the network. Furthermore, since various ingredient providers offer ingredients in different sale units, the shopper can purchase ingredients in the sale units that will provide the shopper with the correct quantities of the ingredients. Furthermore, the request for information is sent to only specific ingredient providers matching the requirements indicated in the registered personal information and, as a result, ingredient information that satisfies the specific requirements of the shopper can be quickly provided. Since selection/non-selection can be specified for individual ingredient categories in advance by registering personal information, the shopper operation is simplified when purchasing ingredients on-line. Since a setting is made to ensure that an excessively large volume of information is not displayed for a given ingredient by registering personal information, the minimum volume of ingredient information is displayed in an easy-to-see manner at the shopper terminal.

### Third Embodiment

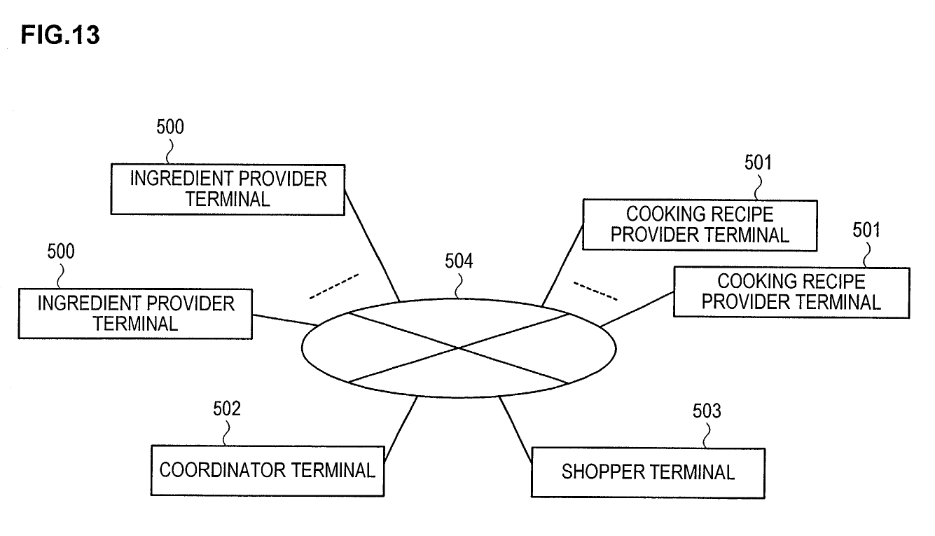

Next, the sales promotional information coordination service system achieved the third embodiment is explained in reference to FIG. 13. FIG. 13 is a block diagram illustrating the structure of the sales promotional information coordination service system achieved in the embodiment.

In the sales promotional information coordination service system in the embodiment, ingredient providers register sales promotional information such as information on ingredient discounts at the coordinator terminal and the cooking recipe providers provide specific cooking recipes based upon the sales promotional information obtained through the coordinator terminal. The shopper can make an on-line purchase of, for instance, ingredients offered at discount prices via an Internet shop simply by selecting a cooking recipe that requires ingredients offered in the sales promotional information.

The sales promotional information coordination service system in the embodiment is constituted by connecting, via a network 504, ingredient provider terminals 500, cooking recipe provider terminals 501, a coordinator terminal 502 and a shopper terminal 503, as shown in FIG. 13.

The ingredient provider terminals 500 transmit sales promotional information such as information on ingredients offered at special prices for the day and information on ingredients in season to the coordinator terminal 502 which is to be detailed later. In addition, the ingredient provider terminal 500 has an Internet shop function to enable the shopper to purchase ingredients on-line.

The cooking recipe provider terminals 501 are each provided with a means through which the sales promotional information registered by the ingredient provider terminals 500 at the coordinator terminal 502 is referenced and a cooking recipe that requires the ingredient offered in the sales promotional information is selected from a cooking recipe database of the cooking recipe provider to offer to shoppers.

The coordinator terminal 502 comprises a means for sales promotional information registration that registers the sales promotional information transmitted from the ingredient provider terminals 500, a means for sales promotional information referencing provided to allow the cooking recipe provider terminals 501 to reference the sales promotional information, a means for user registration that registers ingredient providers and cooking recipe providers who wish to use the system, a means for sales promotional information utilization status management that manages the sales promotional information and records the utilization status, a means for connection verification provided to allow the ingredient provider terminals 500 and the cooking recipe provider terminals 501 to connect with the coordinator terminal 502, a means for charging that charges a fee based upon the status of the utilization by a cooking recipe provider terminal 501 with regard to the sales promotion information registered by an ingredient provider terminal 500, a means for notification that provides the cooking recipe provider terminals 501 with sales promotional information updated by an ingredient provider, and the like.

At the shopper terminal 503, cooking recipes provided by the cooking recipe provider terminals 501, ingredient information provided by the ingredient provider terminals 500 and information provided by the coordinator terminal 502 are displayed. It is provided with a means for input that is used to select a cooking recipe as necessary and to purchase ingredients.

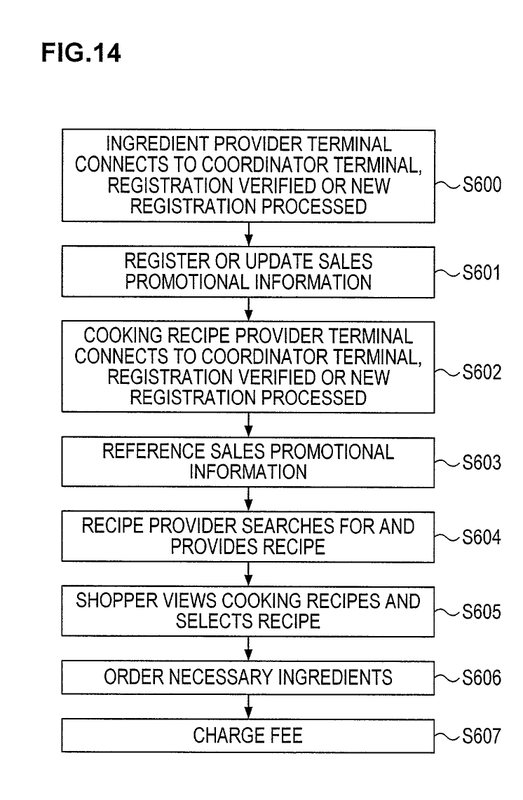

The flow of the operation achieved in the sales promotional information coordination service system in the embodiment is now explained in reference to FIG. 14. FIG. 14 presents a flow chart of the operation achieved in the sales promotional information coordination service system in the embodiment.

First, as shown in FIG. 14, an ingredient provider terminal 500 connects with the coordinator terminal 502 and a verification is made as to whether or not the ingredient provider terminal 500 is a registered user in step S600. If information on the ingredient provider has never been registered, the information is registered at this point (step S600).

In the following step S601, the verified ingredient provider terminal 500 transmits sales promotional information with regard to available ingredients and their prices to the coordinator terminal 502. The coordinator terminal 502 registers the received sales promotional information in its database (step S601).

Whenever the sales promotional information is updated by the ingredient provider terminal 500 in this step, the coordinator terminal 502 provides the cooking recipe provider terminals 501 with the latest sales promotional information. The updated information may be provided to all the cooking recipe provider terminals 501, or cooking recipe provider terminals 501 that will be affected by the update may be selected from all the cooking recipe provider terminals 501 using the sales promotional information to provide the update only to those selected cooking recipe provider terminals 501.

In the following step S602, a cooking recipe provider terminal 501 connects with the coordinator terminal 502 and a verification is made as to whether or not the cooking recipe provider terminal 501 is a registered user. It is to be noted that if the cooking recipe provider has never been registered, the recipe provider is registered at this point (step S602).

Next, in step S603, the verified the cooking recipe provider terminal 501 references the sales promotional information registered at the coordinator terminal 502 (step S603).

Then, in step S604, the cooking recipe provider terminal 501 selects specific ingredients included in the sales promotional information and selects a cooking recipe that requires the selected ingredients from a cooking recipe database of the cooking recipe provider (step S604).

At this time, information indicating the cooking recipe provider who has used the sales promotional information is recorded at the coordinator terminal 502. If there are a plurality of cooking recipes that require ingredients offered in the sales promotional information, the cooking recipe provider can provide cooking recipes freely. For instance, the cooking recipe provider terminal 501 may choose to provide all the selected cooking recipes or it may choose to provide a specific cooking recipe only.

In addition, when an ingredient provider has updated the sales promotional information provided earlier, the updated sales promotional information is provided to the cooking recipe provider terminals via the coordinator terminal 502. Each cooking recipe provider terminal having received the updated information re-selects a cooking recipe to be featured at the cooking recipe site (information page), based upon the updated sales promotional information .

In step S605, the shopper connects his shopper terminal 503 to the cooking recipe provider terminals 501 via the coordinator terminal 502. The shopper selects a cooking recipe through any of various search methods offered at the cooking recipe provider terminals 501 (step S605).

Next, the shopper having selected the cooking recipe performs an operation to place an order for the ingredients required in the cooking recipe in step S606 (step S606). At this time, if the user has selected a cooking recipe provided based upon sales promotional information, priority is given to the ingredient provider who provided the sales promotional information when ordering the ingredients, unless the shopper gives specific instructions to purchase the ingredients from another ingredient provider. In addition, ingredients other than those required in the recipe can be purchased freely from any of the registered ingredient providers.

Information on the cooking recipe selected by the shopper that was provided based upon the sales promotional information and details (the number of orders and the purchase prices) of orders placed to the ingredient provider who provided the sales promotional information is recorded at the coordinator terminal 502.

The coordinator terminal 502 cyclically tabulates the contents of orders placed (the number of customers and the purchase prices) with each ingredient provider and collects a fee from the ingredient provider in step S607. The fee may be paid to the cooking recipe provider in its entirety or in part (step S607).

Since an ingredient provider can provide sales promotional information to cooking recipe sites, ingredients that the ingredient provider wishes to promote are advertised to shoppers (in the form of cooking recipes requiring the ingredients), and thus the ingredient provider can generate profits by cultivating new shoppers in this manner. In addition, a cooking recipe site can not only utilize the sales promotional information but also collect a fee (advertising fee) from the ingredient provider simply by selectively displaying the data contents of its own database.

Furthermore, the shopper only needs to select a recipe at a cooking recipe site, which requires ingredients offered in the sales promotional information and to purchase the necessary ingredients at the sales promotional prices, without having to come up with a suitable cooking recipe after searching for ingredients whose sales are being promoted. The provider of the coordinator terminal may gain a profit by withholding part of the fee collected from the ingredient provider, which is then paid to the cooking recipe provider in whole or in part.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

While an explanation is given in reference to the embodiment on an example in which sales promotional information is coordinated to provide shoppers with both cooking recipes and ingredients, the type of merchandise to be coordinated is not limited to this example. The present invention may be adopted in any coordination of at least two elements of services provided to shoppers, i.e., a specific process method and materials and tools needed to implement the process, such as Sunday carpentry instructions and materials such as lumber, cleaning instructions and cleaning products, gardening instructions and materials including soil and fertilizers, personal computer assembly instructions and personal computer parts and the like.

In addition, while the setting to indicate selection/non-selection for each ingredient category and the setting to indicate what priority order in which a plurality of sets of information with regard to a single ingredient (provided by different vendors, for instance) are to be arranged are explained with regard to the ingredient information display, the present invention is not restricted by these details as long as an effective display method for the shopper is set.

It is not necessary to implement the steps in the order described above. For instance, the ingredient provider terminals may register and update sales promotional information at any time at the coordinator terminal. Furthermore, the cooking recipe provider terminals in the third embodiment may reference the sales promotional information registered at the coordinator terminal any time to update the cooking recipes they provide as necessary. An order placed by a shopper may be processed any time. Also, the coordinator terminal may charge a fee any time, as necessary.

With process elements such as required ingredients and their quantities simply specified through an information page at a process method provider such as an ingredient provider, information from a plurality of ingredient providers is taken in and the compiled information is provided at the shopper terminal. As a result, the shopper can plan with the purchase quantities and the purchase prices of the process elements such as ingredients at home. In addition, since information from a plurality of process element providers such as ingredient providers is first compiled and then the compiled information is provided at the shopper terminal, the shopper has access to more information and more options with regard to the process elements that he needs to purchase.

In addition, since data provided at process method provider sites that provide information on process methods such as cooking recipes on the network and data provided at process element provider sites that provide process elements such as ingredients on the network are utilized, full ingredients can be obtained more easily at all times than through a service in the prior art that is offered through a single store. When ingredients are sold in different sale units by various ingredient providers, the shopper can purchase them in the sale units that will provide the shopper with the desired quantities of ingredients. Furthermore, even a process element provider of such as an ingredient provider who does not offer information on process methods such as cooking recipes, can immediately start providing services simply by becoming connected to the network.

Moreover, since sales promotional information is included in information pages providing shoppers with instructions for implementing a process, sales of process elements to the shoppers can be effectively promoted. As a result, a great number of new shoppers can be cultivated to increase profits. From the shoppers' perspective, process elements such as products offered at discount prices can be purchased simply by viewing the process method information pages.

What is claimed is:

1. A sale quantity information coordination service system constituted by connecting via a network;
a plurality of process method provider terminals at each of which an information page offering information on, at least a specific process method and process elements required to implement the specific process is provided;
a plurality of process element provider terminals at each of which sale quantity information on sale units and sale prices of the process elements required to implement the specific process is provided;
a shopper terminal; and
a coordinator terminal comprising a means for sale quantity information request that issues a request for the sale quantity information with respect to process elements included in the information page to at least one process element provider terminal in response to a request from a shopper terminal, a means for compilation that compiles a plurality of sets of sale quantity information provided by the plurality of process element provider terminals in a specific format and a means for providing sale quantity information that provides said compiled sale quantity information to the shopper terminal that has requested said sale quantity information.

2. A sale quantity information coordination service system according to claim 1, wherein;
said means for compilation compiles said sale quantity information so as to provide a means for process element purchase specification to be used to specify a process element to be purchased for each process element; and
the shopper terminal is capable of placing an order for a process element by specifying the process element through said means for process element purchase specification and transmitting said compiled sale quantity information to said process element provider.

3. A sale quantity information coordination service system according to claim 1, further comprising;
a means for personal information registration that registers information indicating specific conditions under which the process element is to be purchased in correspondence to each shopper, wherein;
said means for sale quantity information request issues a request to said process element providers for sale quantity information based upon said personal information or;
said means for compilation compiles sale quantity information in a specific format based upon said personal information.

4. A sale quantity information coordination service system according to claim 3, wherein;
said personal information includes at least information specifying a method of process element purchase; and
said means for sale quantity information request issues a request for said sale quantity information to process element providers offering process elements on-line if a shopper specifies that the process element is to be purchased on-line, and issues a request for said sale quantity information to process element provider terminals having a store within a specific distance from the shopper terminal that has issued a request for said sale quantity of information if the shopper specifies that the process element is to be purchased at a store.

5. A sale quantity information coordination service system according to claim 3, wherein;
said personal information includes process element purchase specification information specifying in advance process elements to be purchased or process elements not to be purchased; and
said means for compilation compiles said sale quantity information so as to specify in advance process elements to be purchased through said means for process element purchase specification based upon said process element purchase specification information or compiles said sale quantity information so as to ensure in advance that process elements not to be purchased are not specified through said means for process element purchase specification based upon said process element purchase specification information.

6. A sale quantity information coordination service system according to claim 3, wherein;
said personal information includes purchase condition specification information for specifying purchase conditions for purchasing process elements with priority order ranks attached thereto; and
said means for compilation compiles said sale quantity information so as to provide a specific number of sets of sale quantity information based upon priority order ranks included in said purchase condition specification information and to indicate that there is a further choice in purchasing process elements apart from options offered in said sale quantity information provided by said means for compilation.

7. A sale quantity information coordination service system according to claim 3, wherein;
said means for sale quantity information request issues a request to predetermined process element provider terminals for sale quantity information if sales promotional information is requested by a shopper terminal that has not registered said personal information.

8. A terminal device connected via a network, with;
a plurality of process method provider terminals at each of which an information page offering information on, at least a specific process method and process elements required to implement the specific process is provided;
a plurality of process element provider terminals at each of which sale quantity information on sale units and sale prices of the process elements required to implement the specific process is provided; and
a shopper terminal, with said terminal device comprising;
a means for sale quantity information request that issues a request for the sale quantity information with respect to process elements included in the information page to at least one process element provider terminal in response to a request from a shopper terminal, a means for compilation that compiles a plurality of sets of sale quantity information provided by the plurality of process element provider terminals in a specific format and a means for providing sale quantity information that provides said compiled sale quantity information to the shopper terminal that has requested said sale quantity information.

9. A terminal device according to claim 8, wherein;
said means for compilation compiles said sale quantity information so as to provide a means for process element purchase specification to be used to specify a process element to be purchased for each process element.

10. A terminal device according to claim 8, further comprising;
a means for personal information registration that registers information indicating specific conditions under which the process element is to be purchased in correspondence to each shopper, wherein;
said means for sale quantity information request issues a request to said process element providers for sale quantity information based upon said personal information or;
said means for compilation compiles sale quantity information in a specific format based upon said personal information.

11. A terminal device according to claim 10, wherein;
said personal information includes at least information specifying a method of process element purchase; and
said means for sale quantity information request issues a request for said sale quantity information to process element providers offering process elements on-line if a shopper specifies that the process element is to be purchased on-line, and issues a request for said sale quantity information to process element provider terminals having a store within a specific distance from the shopper terminal that has issued a request for said sale quantity of information if the shopper specifies that the process element is to be purchased at a store.

12. A terminal device according to claim 10, wherein;
said personal information includes process element purchase specification information specifying in advance process elements to be purchased or process elements not to be purchased; and
said means for compilation compiles said sale quantity information so as to specify in advance process elements to be purchased through said means for process element purchase specification based upon said process element purchase specification information or compiles said sale quantity information so as to ensure in advance that process elements not to be purchased are not specified through said means for process element purchase specification based upon said process element purchase specification information.

13. A terminal device according to claim 10, wherein;
said personal information includes purchase condition specification information for specifying purchase conditions for purchasing process elements with priority order ranks attached thereto; and
said means for compilation compiles said sale quantity information so as to provide a specific number of sets of sale quantity information based upon priority order ranks included in said purchase condition specification information and to indicate that there is a further choice in purchasing process elements apart from options offered in said sale quantity information provided by said means for compilation.

14. A terminal device according to claim 10, wherein;
said means for sale quantity information request issues a request to predetermined process element provider terminals for sale quantity information if sales promotional information is requested by a shopper terminal that has not registered said personal information.

15. A medium having recorded therein a program for achieving a terminal device according to claim 8.

16. A medium having recorded therein a program for achieving a terminal device according to claim 9.

17. A medium having recorded therein a program for achieving a terminal device according to claim 10.

18. A medium having recorded therein a program for achieving a terminal device according to claim 11.

19. A medium having recorded therein a program for achieving a terminal device according to claim 12.

20. A medium having recorded therein a program for achieving a terminal device according to claim 13.

21. A medium having recorded therein a program for achieving a terminal device according to claim 14.

22. A sales promotional information coordination service system constituted by connecting via a network;
a plurality of process method provider terminals at each of which an information page offering information on a specific process method is provided;
a plurality of process element provider terminals at each of which information related to process elements required to implement the specific process is provided;
a shopper terminal; and
a coordinator terminal, comprising;
a means for process element provider terminal registration that registers said process element provider terminals;
a means for process method provider terminal registration that registers said process method provider terminals;
a means for sales promotional information registration that registers information related to process elements, the sales of which are being promoted by said process element providers;
a means for providing sales promotional information that provides said registered sales promotional information to said process method provider terminals;
a means for process element provider terminal verification that verifies whether or not said process element provider terminals are registered when registering said sales promotional information;
a means for process method provider terminal verification that verifies whether or not said process method provider terminals requesting said sales promotional information are registered; and
a means for charging that charges a process element provider terminal that has registered said sales promotional information for a fee.

23. A sales promotional information coordination service system according to claim 22, wherein;
in said information page provided at each of said process method provider terminals, at least one process method is offered based upon at least one set of sales promotional information received through said means for providing sales promotional information; and
a process element included in said information page providing the process method can be directly ordered from said information page.

24. A sales promotional information coordination service system according to claim 22, wherein;
said coordinator terminal further comprises a means for recording that records a process method provider terminal which has used said registered sales promotional information as data indicating a correlation to the process element provider terminal that registered said sales promotional information.

25. A sales promotional information coordination service system according to claim 22, wherein;
said coordinator terminal further comprises a means for notification that provides at least a process method provider terminal that has used original sales promotional information with updated sales promotional information if the registered original sales promotional information is updated.

26. A sales promotional information coordination service system according to claim 22, wherein;
said coordinator terminal further comprises;
a means for recording that records information indicating that a shopper has purchased a process element based upon sales promotional information used by one of said process method provider terminals;
a means for calculation that calculates a fee to be charged to said process element provider that provided said sales promotional information based upon said recorded information;
a means for fee collection that collects the fee from said process element provider that provided said sales promotional information based upon the results of calculation; and
a means for fee payment that pays at least part of the fee to said process method provider that has used said sales promotional information based upon the results of calculation.

27. A terminal device connected via a network with;
a plurality of process method provider terminals at each of which an information page offering information on a specific process method is provided;
a plurality of process element provider terminals at each of which information related to process elements required to implement the specific process is provided; and
a shopper terminal;
a means for process method provider terminal registration that registers said process method provider terminals;
a means for sales promotional information registration that registers information related to process elements, the sales of which are being promoted by said process element providers;
a means for providing sales promotional information that provides said registered sales promotional information to said process method provider terminals;
a means for process element provider terminal verification that verifies whether or not said process element provider terminals are registered when registering said sales promotional information;
a means for process method provider terminal verification that verifies whether or not said process method provider terminals requesting said sales promotional information are registered; and
a means for charging that charges a process element provider terminal that has registered said sales promotional information for a fee.

28. A terminal device according to claim 27, further comprising;
said coordinator terminal further comprises a means for recording that records a process method provider terminal which has used said registered sales promotional information as data indicating a correlation to the process element provider terminal that registered said sales promotional information.

29. A terminal device according to claim 27, further comprising;
a means for notification that provides at least a process method provider terminal that has used original sales promotional information with updated sales promotional information if the registered original sales promotional information is updated.

30. A terminal device according to claim 27, further comprising;
a means for recording that records information indicating that a shopper has purchased a process element based upon sales promotional information used by one of said process method provider terminals;
a means for calculation that calculates a fee to be charged to said process element provider that provided said sales promotional information based upon said recorded information;
a means for fee collection that collects the fee from said process element provider that provided said sales promotional information based upon the results of calculation; and
a means for fee payment that pays at least part of the fee to said process method provider that has used said sales promotional information based upon the results of calculation.

31. A medium having recorded therein a program for achieving a terminal device according to claim 27.

32. A medium having recorded therein a program for achieving a terminal device according to claim 28.

33. A medium having recorded therein a program for achieving a terminal device according to claim 29.

34. A medium having recorded therein a program for achieving a terminal device according to claim 30.
